(19) United States
(12) Patent Application Publication
(10) Pub. No.: US 2012/0176857 A1
(43) Pub. Date: Jul. 12, 2012

(54) Reducer Assembly For An Industrial Mixer

(76) Inventors: Gerald Victor Fleishman, Holland, MI (US); Matthew Dale Kammeraad, Holland, MI (US)

(21) Appl. No.: 13/348,705

(22) Filed: Jan. 12, 2012

Related U.S. Application Data
(60) Provisional application No. 61/431,910, filed on Jan. 12, 2011.

(51) Int. Cl. B01F 13/00; F16H 7/02

(52) U.S. Cl. 366/343; 474/148

(57) ABSTRACT

A reducer for an industrial motor including a housing assembly, an input shaft assembly, an output shaft assembly and a cogged belt. The housing assembly defines a cavity. The input shaft assembly includes a first sprocket. The input shaft assembly is coupled to the housing assembly and positioned within the housing. The input shaft is configured for coupling to a motor positioned outside of the cavity through the input opening. The output shaft assembly includes a second sprocket, and is coupled to the housing assembly while being positioned within the housing. The output shaft is configured for coupling to a mixer agitator assembly having an impeller positioned outside of the cavity through the output opening. The cogged belt couples the first sprocket to the second sprocket and being positioned within the cavity.

### CROSS-REFERENCE TO RELATED APPLICATION

This application claims priority from U.S. Provisional Patent App. Ser. No. 61/431,910 filed Jan. 12, 2011, entitled “Reducer Assembly For An Industrial Mixer”, the entire specification of which is hereby incorporated by reference in its entirety.

### BACKGROUND OF THE DISCLOSURE

1. Field of the Disclosure

The disclosure relates in general to a reducer assembly, and more particularly, to a reducer assembly for an industrial mixer. Although not exclusively limited for use in a particular field of industry, it will be understood that the reducer assembly of the present invention is well suited for use in association with an industrial mixer for use in association with paint equipment typically associated with vehicle manufacture and assembly.

2. Background Art

The use of mixers is well known in the art. In one particular application, mixers are utilized which mix and agitate paint in preparation for its application onto a vehicle. It will be understood that this is not the only use for such equipment and other uses are also contemplated.

Typically, such mixers utilize a motor which is connected through a reducer assembly to a rotating shaft with an impeller positioned at the end of the mixer shaft. Generally, the reducer assembly reduces the rotational speed of the motor in a three to one or a five to one reduction (approximately). Of course, it is not limited to such a reduction, and a number of different reduction ratios are contemplated.

To achieve such a reduction, typically, a gear train is incorporated into the reducer assembly. Generally, the gear train is lubricated with grease or oil, and the rotating mixer shafts include a seal which maintains the grease or oil to remain within the reducer. Typically, over time, these seals leak and, in many instances, due to gravity, the grease or oil contaminates the product that is being mixed and agitated.

In the vehicle paint application, such contamination is highly destructive and problematic. Often the leak is not immediately diagnosed and the lubricant mixes with the paint. The lubricant mixed paint is then applied to vehicle bodies, and while problems are not immediately identified, the paint is prone to adhesion failures and warranty claims. In instances wherein the problems are identified, a costly shut down of the paint portion of the assembly line can cause dramatic financial impact.

It is an object of the present invention to overcome the deficiencies in the prior art.

It is another object of the present invention to minimize the possibility of contamination of the product being mixed and/or agitated.

These objects as well as other objects of the present invention will become apparent in light of the present specification, claims, and drawings.

### SUMMARY OF THE DISCLOSURE

The disclosure is directed to a reducer assembly, typically for use in association with an industrial motor. The reducer includes a housing assembly, an input shaft assembly, an output shaft assembly and a cogged belt. The housing assembly defines a cavity. The input shaft assembly includes a first sprocket. The input shaft assembly is coupled to the housing assembly and positioned within the housing. The input shaft is configured for coupling to a motor positioned outside of the cavity through the input opening. The output shaft assembly includes a second sprocket, and is coupled to the housing assembly while being positioned within the housing. The output shaft is configured for coupling to a mixer agitator assembly having an impeller positioned outside of the cavity through the output opening. The cogged belt couples the first sprocket to the second sprocket and being positioned within the cavity.

In some embodiments, the housing assembly further includes a top panel and a bottom panel and a side skirt spanning therebetween. The input opening extends through the top panel and the output opening extends through the bottom panel.

In some embodiments, the top panel and bottom panel are substantially planar and substantially parallel to each other spaced apart by the depending skirt.

In some such embodiments, the side skirt is integrally formed with the top panel.

In some embodiments, the top panel, bottom panel and side skirt are coupled together so as to be separable only through destructive means. Additionally, the top panel, bottom panel and side skirt are substantially continuous with the exception of the input opening and output opening.

In some such embodiments, the top panel, bottom panel and side skirt are at least one of integrally formed, welded, or adhered together so as to be separable through only destructive means.

In some other embodiments, each of the input shaft assembly and the output shaft assembly each include a pair of bearings to facilitate rotation thereof about a respective axis of rotation.

In some other embodiments, the first sprocket has a radius that is smaller than a radius of the second sprocket so that in operable engagement rotation of the first sprocket imparts a slower rotation of the second sprocket through the cogged belt.

In other embodiments, the first sprocket and second sprocket have a rotational ratio of at least 2:1.

In other embodiments, the cavity is substantially free of lubricant.

In another aspect of the disclosure, the disclosure is directed to an industrial mixer assembly. The industrial mixer assembly comprises a motor, a reducer assembly and a mixer agitator assembly. The motor has a motor output shaft. The reducer assembly includes a housing assembly, an input shaft assembly, an output shaft assembly and a cogged belt. The housing assembly defines a cavity. The input shaft assembly includes a first sprocket. The input shaft assembly is coupled to the housing assembly and positioned within the housing. The input shaft is configured for coupling to a motor positioned outside of the cavity through the input opening. The output shaft assembly includes a second sprocket, and is coupled to the housing assembly while being positioned within the housing. The output shaft is configured for coupling to a mixer agitator assembly having an impeller positioned outside of the cavity through the output opening. The cogged belt couples the first sprocket to the second sprocket and being positioned within the cavity. The mixer agitator assembly has a mixer shaft coupled to the output shaft of the reducer assembly at a first end, and an impeller proximate the opposing end.

In some embodiments, the motor output shaft, the input shaft, the output shaft and the mixer shaft are substantially parallel to each other.

In some other embodiments, the motor is mounted to the housing at one end and the mixer agitator assembly is mounted to the housing at an end opposing the end to which the motor is mounted.

In some other embodiments, the housing assembly further includes a top panel and a bottom panel and a side skirt spanning therebetween. The input opening extends through the top panel and the output opening extends through the bottom panel.

In some other embodiments, the motor is mounted to the top panel and the mixer agitator assembly is mounted to the bottom panel.

In some other embodiments, the top panel and bottom panel are substantially planar and substantially parallel to each other spaced apart by the depending skirt.

In some such embodiments, the top panel, bottom panel and side skirt are coupled together so as to be separable only through destructive means. Additionally, the top panel, bottom panel and side skirt are substantially continuous with the exception of the input opening and output opening.

In some embodiments, the top panel, bottom panel and side skirt are at least one of integrally formed, welded, or adhered together so as to be separable through only destructive means.

In some embodiments, each of the input shaft assembly and the output shaft assembly each include a pair of bearings to facilitate rotation thereof about a respective axis of rotation.

It will be understood that the configuration of the sprockets can be modified within the scope of the invention, and the cogs can be eliminated in certain embodiments.

### BRIEF DESCRIPTION OF THE DRAWINGS

The disclosure will now be described with reference to the drawings wherein:

FIG. 1 of the drawings is a side elevational view of an industrial mixer having the reducer assembly of the present disclosure;

FIG. 2 of the drawings is a partial perspective view of the industrial mixer having the reducer assembly of the present disclosure;

FIG. 3 of the drawings is an exploded perspective view of the industrial mixer having the reducer assembly of the present disclosure; and

FIG. 4 of the drawings is a side elevational view of an industrial mixer having the reducer assembly of the present invention in an operating environment.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

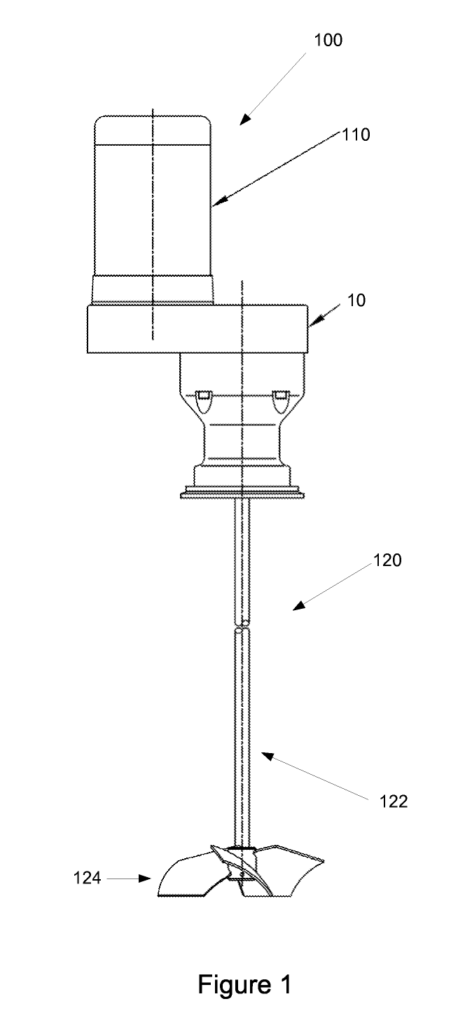

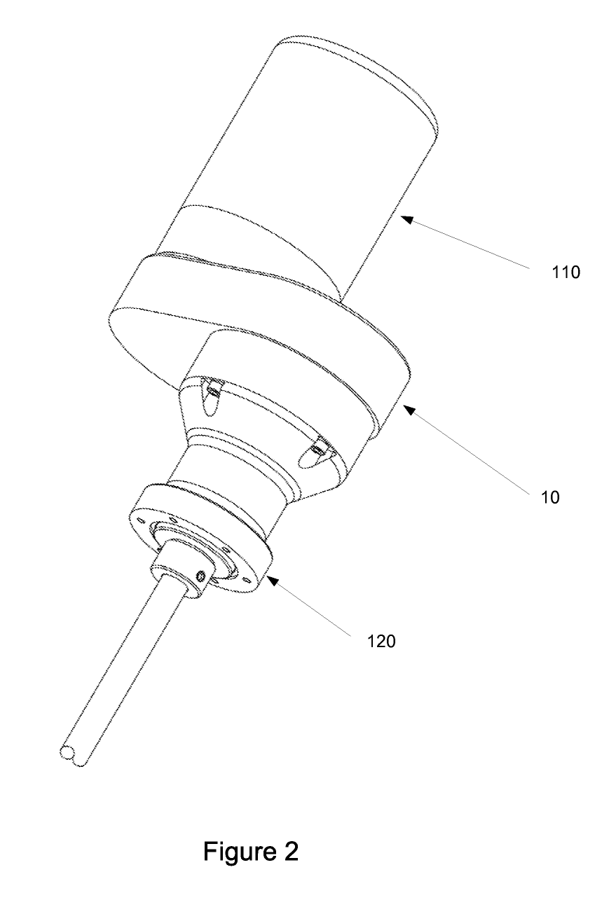

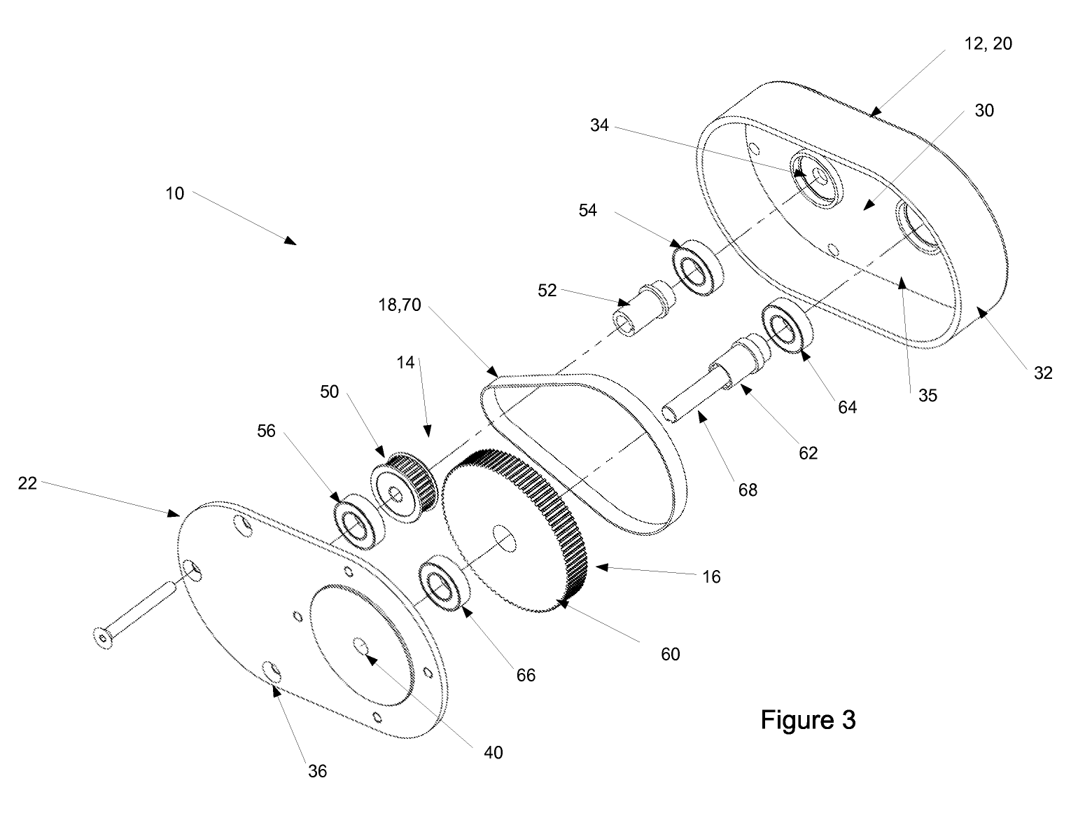

Referring now to the drawings and in particular to FIG. 3, reducer assembly 10 is shown as comprising housing assembly 12, input shaft assembly 14, output shaft assembly 16 and coupling member 18. With reference to FIGS. 1 and 2, the reducer assembly 10 is incorporated into a mixer 100 having motor 110 (typically an electric motor with an output shaft) and mixer agitator assembly 120. The electric motor may be of any number of different constructions and may have variable speeds. In one embodiment, the motor has at least three speeds, namely 850 rpm, 1150 rpm and 1750 rpm. Of course, the disclosure is not limited to any particular configuration of the motor or to any particular type of motor. With reference to FIG. 1, the mixer agitator assembly 120 includes shaft 122 and impeller 124. The impeller 124 may be any one of a number of designs, and the disclosure is not limited to any particular configuration.

Referring again to FIG. 3, the housing assembly 12 includes upper housing member 20 and lower housing member 22. The upper housing member 20 includes top panel 30, side skirt 32 which depends from the top panel 30 about the circumference thereof. The top panel and the side skirt together define cavity 35 into which the input shaft assembly and the output shaft assembly are positioned. The top panel includes input opening 34 and housing attachment structure 36. In the embodiment shown, the motor attachment structure includes openings which are configured to match openings on the motor. As a result, fasteners can be extended through the openings so as to be coupled to the motor, to, in turn, fasten the motor to the upper housing member.

The lower housing member 22 defines a bottom panel which includes an output opening 40 which provides an opening and access into the cavity 35. The output opening is configured to provide access to the output shaft assembly for connecting thereto. In the embodiment shown, the side skirt is coupled to the upper housing member. In other embodiments, the side skirt may be coupled to the lower housing member, or may be a separate member altogether. It will be understood that generally there is an top and bottom panel (or panels) through which the shafts extend and there is a member which extends therebetween which is referred to as the side skirt. It will also be understood that the top panel may comprise a plurality of panels which may have a number of different shapes and configurations. The same may be the case with the bottom panel. It is likewise preferred that the only openings on the housing comprise the input opening and the output opening, so that the unit is substantially entirely closed thereby limiting the debris that can be transmitted into and out of the cavity (other than fastener openings utilized for coupling the motor and the mixer assemblies).

The upper housing member is coupled to the lower housing member through any number of different means, which includes welding, adhesive and fastening. It is preferred that the attachment of the upper housing member to the lower housing member be achieved through a largely permanent solution wherein disassembly in the field through non destructive measures is limited and discouraged (i.e., solely through destructive means). Of course, the disclosure is not limited to any particular joining method or application. In the embodiment shown, a plurality of fasteners are provided, and in addition, the upper and lower housing members may be welded together. The fasteners may be utilized for assembly purposes nevertheless and for coupling of the motor and mixer assemblies.

Typically, the housing assembly 12 comprises a metal member, such as steel or aluminum, while other materials are contemplated, such as different metals, alloys thereof or other materials such as plastics and reinforced composites. In the embodiment contemplated, the length of the housing assembly 12 is approximately 11.77 inches, the width is approximately 7 inches and the thickness is approximately 2.55 inches. The distance between the two axis of revolution of the sprockets is 4.77 inches.

The input shaft assembly 14 is shown as comprising sprocket 50, drive shaft 52 and bearings 54, 56. The input shaft assembly 14 is configured so as to be coupled to the drive shaft of the motor 100. The drive shaft 52 can be coupled to the drive shaft of the motor 100 as well as to the sprocket 50. The particular configuration (i.e., number of cogs, width of the pulley, etc.) can be varied depending on the application. The bearings 54, 56 provide the necessary surfaces about which the drive shaft 52 is to spin. The sprocket may comprise a metal member, a polymer member, or a reinforced composite member.

The output shaft assembly comprises sprocket 60, drive shaft 62, bearing 64-66 and impeller agitator assembly attachment 68. The output shaft assembly is configured so as to be coupled to the shaft 122 of the mixer agitator assembly 120. The drive shaft 62 in particular is coupled on the one hand to the sprocket 60 and on the other hand to the impeller agitation attachment 68 (which may comprise shaft 122 or which may be a separate component which is coupled to shaft 122 of the mixer agitator assembly 120).

The sprocket 60 may comprise a particular number of cogs and a particular width which can be varied depending on the application. It will be understood that the relationship between the cogs of sprocket 50 and sprocket 60 determines the reduction ratio of the reducer assembly 10. In the embodiment shown, the shaft 122 of the mixer agitator 120 spins at roughly one third the revolutions of the motor 110. In other embodiments, this reduction can be altered to any number of different ratios. In a particular embodiment, the ratio is 2.82:1 in which the pitch diameter of the sprocket 50 is 2.005 inches and the sprocket has 32 cogs. In such an embodiment, the pitch diameter of the sprocket 60 is 5.639 inches and the sprocket has 90 cogs. Of course, such a configuration is only one of a number of different configurations and combinations which can yield any number of different reduction ratios, although a ratio of at least 2:1 is preferred. The two sprockets are coupled to each other by way of cogged belt 70 which is the coupling member 18. In certain embodiments, the cogs can be eliminated from each of the pulleys and the belt, however, it will be understood that with the cogs, it is easier to control rotation as slippage may result from the utilizing of pulleys having smooth surfaces and belts having smooth surfaces. Where relative movement (slipping) is significant or problematic, such cogged belts with sprockets are helpful. In addition, such a construction substantially eliminates the need for use of a lubricant. As such, no lubricant is applied within the cavity, in preferred embodiments.

In operation, the motor 110 is connected to the reducer assembly 10 and in particular to the input shaft assembly 14 and the shaft 52 thereof. Similarly, the shaft 122 of the mixer agitator assembly 120 is coupled to the shaft 62 of the output shaft assembly. Thus, when the motor is activated, the motor rotates at a particularly desired rotational rate. This rotation imparts rotation to the sprocket 50 which through the cogged belt 70 imparts rotation onto the sprocket 60. In turn, the rotation of the sprocket 60 imparts rotation onto the shaft 122 and, in turn, the impeller 124.

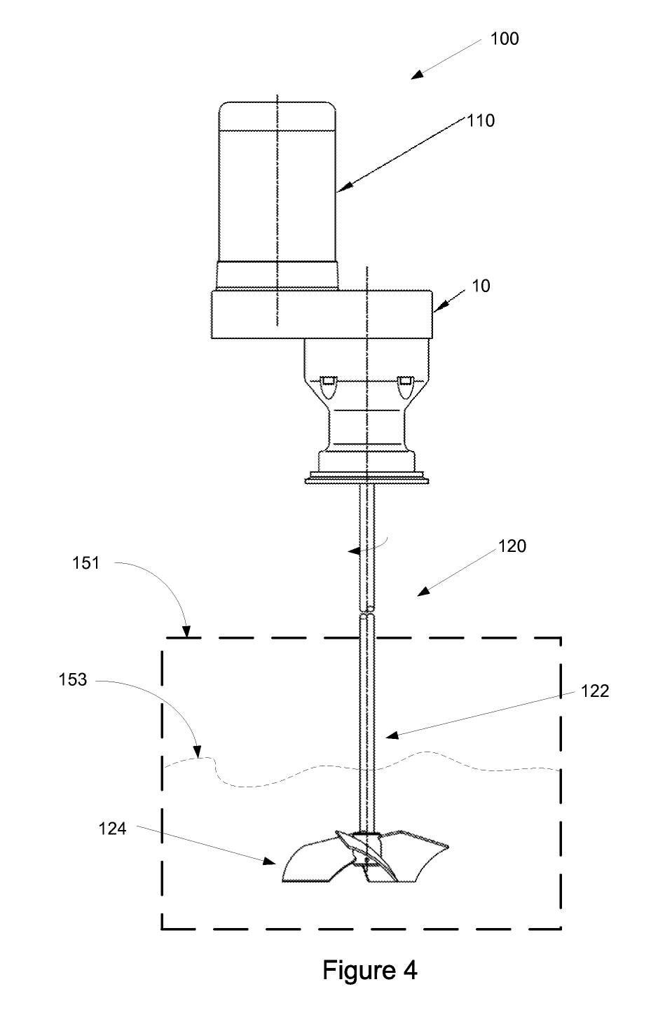

An operational environment is shown in FIG. 4, wherein the mixer 100 is positioned with its impeller 124 in a large paint mixing container 151 having paint 153 positioned therein. In such an embodiment, substantially the entirety of the mixer 100 is positioned directly above the mixing container. As will be understood with the prior art reducer assemblies, any leaking of the reducer assembly of the prior art (which is lubricant filled) will tend to be through gravity directed toward and into the mixing container. Problematically, the mixing container, in the embodiment shown, includes a paint which is intended for application onto a vehicle body. The paint is typically not compatible with any leaking lubricants from typical reducers. Any mixing of lubricant with the paint products results in poor adhesion of the paint onto the vehicle. In some instances, the vehicle paint is compromised and a repaint is necessary. Once the problems are identified, it becomes necessary to shut down the paint assembly line for repairs. Any such shut down of the paint assembly line results in dramatic negative financial impact.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A reducer for an industrial motor comprising:
a housing assembly defining a cavity with an input opening and an output opening;
an input shaft assembly which includes a first sprocket, the input shaft assembly coupled to the housing assembly and positioned within the housing, the input shaft being configured for coupling to a motor positioned outside of the cavity through the input opening;
an output shaft assembly which includes a second sprocket, the output shaft assembly coupled to the housing assembly and positioned within the housing, the output shaft being configured for coupling to a mixer agitator assembly having an impeller positioned outside of the cavity through the output opening; and
a cogged belt coupling the first sprocket to the second sprocket and being positioned within the cavity.

2. The reducer for an industrial motor of claim 1 wherein the housing assembly further includes a top panel and a bottom panel and a side skirt spanning therebetween, the input opening extending through the top panel and the output opening extending through the bottom panel.

3. The reducer for an industrial motor of claim 2 wherein the top panel and bottom panel are substantially planar and substantially parallel to each other spaced apart by the depending skirt.

4. The reducer for an industrial motor of claim 3 wherein the side skirt is integrally formed with the top panel.

5. The reducer for an industrial motor of claim 2 wherein the top panel, bottom panel and side skirt are coupled together so as to be separable only through destructive means, and, wherein the top panel, bottom panel and side skirt are substantially continuous with the exception of the input opening and output opening.

6. The reducer for an industrial motor of claim 5 wherein the top panel, bottom panel and side skirt is at least one of integrally formed, welded, or adhered together so as to be separable through only destructive means.

7. The reducer for an industrial motor of claim 1 wherein each of the input shaft assembly and the output shaft assembly each include a pair of bearings to facilitate rotation thereof about a respective axis of rotation.

8. The reducer for an industrial motor of claim 1 wherein the first sprocket has a radius that is smaller than a radius of the second sprocket so that in operable engagement rotation of the first sprocket imparts a slower rotation of the second sprocket through the cogged belt.

9. The reducer for an industrial motor of claim 8, wherein the first sprocket and second sprocket have a ratio of at least 2:1.

10. The reducer for an industrial motor of claim 1, wherein the cavity is substantially free of lubricant.

11. An industrial mixer assembly comprising:
an motor having an motor output shaft;
a reducer assembly comprising:
a housing assembly having an upper housing member and a lower housing member which defines a cavity with an input opening and an output opening;
an input shaft assembly which includes a first cogged sprocket, the input shaft assembly coupled to the housing assembly and positioned within the housing, the input shaft being configured for coupling to a motor positioned outside of the cavity through the input opening, the input shaft coupled to the motor output shaft;
an output shaft assembly which includes a second cogged sprocket, the output shaft assembly coupled to the housing assembly and positioned within the housing, the output shaft being configured for coupling to a mixer agitator assembly having an impeller positioned outside of the cavity through the output opening; and
a cogged belt coupling the first cogged sprocket to the second cogged pulley sprocket and being positioned within the cavity; and
a mixer agitator assembly having a mixer shaft coupled to the output shaft of the reducer assembly at a first end, and an impeller proximate the opposing end.

12. The industrial mixer assembly of claim 11 wherein the motor output shaft, the input shaft, the output shaft and the mixer shaft are substantially parallel to each other.

13. The industrial mixer assembly of claim 11 wherein the motor is mounted to the housing at one end and the mixer agitator assembly is mounted to the housing at an end opposing the end to which the motor is mounted.

14. The industrial motor assembly of claim 13 wherein the housing assembly further includes a top panel and a bottom panel and a side skirt spanning therebetween, the input opening extending through the top panel and the output opening extending through the bottom panel.

15. The industrial mixer assembly of claim 14 wherein the motor is mounted to the top panel and the mixer agitator assembly is mounted to the bottom panel.

16. The industrial mixer assembly of claim 11 wherein the top panel and bottom panel are substantially planar and substantially parallel to each other spaced apart by the depending skirt.

17. The industrial mixer assembly of claim 14 wherein the top panel, bottom panel and side skirt are coupled together so as to be separable only through destructive means, and, wherein the top panel, bottom panel and side skirt are substantially continuous with the exception of the input opening and output opening.

18. The industrial mixer assembly of claim 17 wherein the top panel, bottom panel and side skirt is at least one of integrally formed, welded, or adhered together so as to be separable through only destructive means.

19. The industrial mixer assembly of claim 1 wherein each of the input shaft assembly and the output shaft assembly each include a pair of bearings to facilitate rotation thereof about a respective axis of rotation.

20. The industrial mixer assembly of claim 1, wherein the cavity is substantially free of lubricant.
